(19) United States
(12) Patent Application Publication
(10) Pub. No.: US 2014/0259859 A1
(43) Pub. Date: Sep. 18, 2014

(54) ANIMAL BAIT WITH GROUND ENGAGEMENT SHAPE

(71) Applicant: Rick SCHMIDT, Gambrills, MD (US)

(72) Inventor: Rick SCHMIDT, Gambrills, MD (US)

(21) Appl. No.: 14/169,225

(22) Filed: Jan. 31, 2014

Related U.S. Application Data
(63) Continuation-in-part of application No. 13/826,879, filed on Mar. 14, 2013.

(51) Int. Cl. A01M 31/00

(52) U.S. Cl. CPC A01M 31/008
USPC 43/2

(57) ABSTRACT

A bait for attracting animals and configured for inserting into the ground. The bait includes a shaft portion having a center portion having a first end and a second end, the first and second ends being at opposite ends along a longitudinal direction of the center portion, and a protrusion extending from the center portion, the protrusion being adapted for engaging the ground as the center portion is inserted into the ground; and a head portion attached to the second end of the center portion. The shaft portion and the head portion are a food for the animals.

### RELATED APPLICATIONS

This application is a continuation-in-part of U.S. patent application Ser. No. 13/826,879, filed Mar. 14, 2013.

### BACKGROUND OF THE INVENTION

1. Field of the Disclosed Embodiments

The disclosed embodiments relate to attracting animals.

2. Introduction

Many people attract wild animals for observation, food, sport, or other reasons. As an aid in pursuing these and other interests, baits are sometimes used to attract the animals. Many types of baits are available including liquid scents, salt blocks, pelletized food, and other attractants. These baits have disadvantages that, in most, if not all, cases, include quick dissipation and a lack of ability to stand up to weather.

As a result, there is a need for a bait that resists degradation from weather and is not quickly consumed or carried off by the animals.

### SUMMARY

Particular embodiments of the invention are directed to a bait for attracting animals and configured for inserting into the ground. The bait includes a shaft portion having a center portion having a first end and a second end, the first and second ends being at opposite ends along a longitudinal direction of the center portion, and a protrusion extending from the center portion, the protrusion being adapted for engaging the ground as the center portion is inserted into the ground; and a head portion attached to the second end of the center portion. The shaft portion and the head portion are a food for the animals.

Particular embodiments of the invention are directed to a bait for attracting animals and configured for inserting into the ground. The bait includes a shaft portion having an engagement feature; and a head portion attached to the shaft portion. The portion and the head portion are a food for the animals, and the shaft portion is configured such that the engagement feature engages the ground and resists removal of the bait from the ground when the center portion is inserted into the ground.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 is a view of a first embodiment of the invention;

FIG. 2 is a section view of the embodiment shown in FIG. 1;

FIG. 3 is a top view of the embodiment shown in FIG. 1;

FIG. 4 is a top view of a second embodiment of the invention;

FIG. 5 is a top view of a third embodiment of the invention;

FIGS. 6 and 7 show an example of a method for installing an embodiment of the invention;

FIG. 8 shows an embodiment of the invention in an installed state;

FIGS. 9 and 10 show a fourth embodiment of the invention;

FIG. 11 shows a fifth embodiment of the invention; and

FIG. 12 shows an example of a method for installing the embodiments shown in FIGS. 9-11.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

Various embodiments of the disclosed embodiments may be discussed in detail below. While specific implementations may be discussed, it should be understood that this be may be done for illustration purposes only. A person skilled in the relevant art may recognize that other components and configurations may be used without parting from the spirit and scope of the disclosed embodiments.

The disclosed embodiments comprise a variety of embodiments, such as a method and apparatus and other embodiments that relate to the basic concepts of the disclosed embodiments.

As explained above, the problem with many available baits is that they are quickly consumed by the animals or are easily carried off by the animals. Both of these problems result in fewer return visits by the animals to the location at which the bait was originally set.

To address these problems, the invention provides a bait that is inserted into the ground in such a way that it is difficult for an animal to remove the bait and carry it away. Also, the bait stands up well to weather because the majority of the bait is in the ground and the composition of the bait is somewhat water resistant.

The drawings show exemplary embodiments of the invention.

FIG. 1 shows an example of a bait 10 in accordance with the invention. Bait 10 has a head 100 and a shaft 200. Shaft 200 has a center section 210 and a helical thread 240. In this example, thread 240 protrudes from center section 210 in a helical manner from a first end 220 to a second end 230. Head 100 is attached to center section 210 at second end 230. In this example, head 100 includes a hole 110 that passes completely through head 100. Hole 110 can receive a tool that facilitates installation of bait 10 into the ground (described in more detail below).

FIG. 2 is a sectional view of the embodiment shown in FIG. 1. As can be seen from FIG. 2, the entirety of bait 10 is formed in one piece. In particular embodiments, the entirety of bait 10 is formed from a single material. The material from which bait 10 is formed is a material that the target animal considers food and is attracted to. One example of the material is a mixture of corn chips, sugar, corn syrup, and other natural flavorings. In an exemplary manufacturing process of bait 10, these ingredients are mixed together, heated, poured into a mold, and allowed to set. The mold is then removed producing a solid structure made entirely of the material. This finished product is strong enough to be screwed into the ground without breaking (described in more detail below).

Other examples of materials that can be used are salts, calcium, phosphorous, sodium bicarbonate, other minerals, synthetic urine, natural urine, sugar beet smash, proteins, and glandular materials and their secretions such as tarsal gland, interdigital gland, orbital gland, vaginal secretions, hormones and pheromones. In some embodiments, one or more of these ingredients is included in an amount up to about 30 percent of the total volume with the rest of the total volume being an inert ingredient such as corn chips, sugar, corn syrup, etc.

In the example of sodium bicarbonate, the sodium bicarbonate can be heated to a temperature of approximately 250 degrees Fahrenheit and poured into a mold.

FIG. 3 is a top view of the embodiment shown in FIGS. 1 and 2. In this example, head 100 is round, however other head configurations are also possible. For example, FIG. 4 shows a head 100′ that is round except for two flat sides 120 that oppose each other. Flat sides 120 can be gripped by a tool, such as, for example, a large wrench or clamp, to facilitate installing bait 10 into the ground. FIG. 5 shows a head 100″ that includes an engagement area 130 for receiving a tool, such as, for example, a large bit that resembles a Phillips head screwdriver. While FIGS. 3-5 show particular examples of features for receiving particular tools, it is noted that other shapes and configurations can also be used. The configuration shown in FIGS. 3-5 (and other shapes and configurations) can also exist in the embodiments shown in FIGS. 9-11, below. These configurations can facilitate the installation of the embodiments into the ground.

FIGS. 6-8 show an example of an installation method for particular embodiments of the invention. FIG. 6 shows a hole making tool 400 being inserted into the ground 300 and moved back and forth and around (as illustrated by arrows A) to create a hole, for example a conical hole, in the ground. Hole making tool 400 can be, for example, a large screwdriver, a piece of reinforcing steel, or other tool. FIG. 7 shows bait 10 being screwed into the hole formed in FIG. 6 in the ground 300. FIG. 7 shows a rotation tool 410 inserted in hole 110 to provide leverage for twisting bait 10 in the direction shown by arrow B. Bait 10 is rotated repeatedly and, if necessary, pushed toward the ground so that thread 240 engages the ground and pulls bait 10 downward. Although FIG. 7 shows the use of rotation tool 410, it is noted that such a tool may not be necessary and bait 10 can possibly be screwed into the ground by hand without the use of the tool. FIG. 8 shows bait 10 fully installed in the ground with only head 100 extending above the ground.

In the installed position shown in FIG. 8, any animals attracted by bait 10 will only have access to head 100 until such time as head 100 has been eaten or clawed away. Experience has shown that once head 100 has been eaten or clawed away, the animals will continue to dig in the ground to uncover shaft 200 so that they can continue to feed on bait 10. This results in a bait that draws animals to the same location for a longer period of time than traditional baits. Also, because (1) the material from which bait 10 is made is at least somewhat water resistant, and (2) because the majority of bait 10 is underground, bait 10 is far more weather resistant than traditional baits.

It is noted that the proportions and relative sizes of the elements of the examples shown in the figures are exemplary only and are not limiting. Different sizes and proportions of the elements can be used as long as bait 10 is strong enough and shaped properly to allow insertion into the ground. One example of bait 10 has a head 110 that is 3½ inches in diameter and 2 inches tall, a shaft that is 10 1/2 inches long with an upper end having a diameter of 2½ inches and a helical thread that encircles center section 210 6½ times. These dimensions represent just one example of a possible embodiment of the invention. For example, the helical thread can encircle the center section more or fewer times.

An example of a rotation tool that engages hole 110 for facilitating rotation of bait 10 into the ground has a plate configured to be positioned above head portion 100 and a rod attached to the plate that extends into hole 110. Two or more ears extend up from the plate to provide places to be pushed on to rotate the plate and, in turn, bait 10.

FIGS. 9-11 show an example of another embodiment of the invention. This example is similar to the embodiment shown in FIGS. 1 and 2, except that the helical thread is replaced by one or more barbs. As shown in FIG. 9, a bait 1000 has a head 1100 and a shaft 1200. Shaft 1200 has a center section 1210 and at least one barb 1240, 1250, 1260. Head 1100 is attached to center section 1210 at second end 1230. In this example, barbs 1240, 1250, 1260 extend from center section 1210 in an outwardly direction. Barbs 1240, 1260 extend such that spaces 1241, 1261 are formed between edges 1242, 1262 and center section 1210. In a slightly different configuration, barb 1250 extends such that an upper surface of barb 1250 is parallel to an upper surface of head 110 so that no space is formed between edge 1252 and center section 1210. Barbs 1240, 1250, 1260 are shown in this example to illustrate possible configurations and numbers of barbs. Any number of barbs can be used in any combination of configurations. For example, one, two or more barbs can be used, all of which have the configuration of barb 1240, or one barb having the configuration of barb 1250 can be used. In some embodiments, the lowest barb is located near a first end 1220 of center section 1210 so that bait 1000 remains fixed to the ground until almost all of the bait is consumed.

FIG. 10 is a sectional view of the embodiment shown in FIG. 9. As can be seen from FIG. 10, the entirety of bait 1000 is formed in one piece. In particular embodiments, the entirety of bait 1000 is formed from a single material. Bait 1000 can be formed from the same materials as the embodiments discussed above.

Although barbs 1240, 1250, 1260 are shown in FIGS. 9-11 as completely encircling center section 1210, the barbs can be interrupted or be formed as individual barbs that extend less than completely around center section 1210. FIG. 11 shows examples of a barb 1270 that extends less than completely around center section 1210 and barbs 1280 formed as individual spikes that extend from center section 1210. However, the structural integrity and strength of the barbs should be such that the barbs will remain attached to center section 1210 during and after installation of bait 1000 into ground 300.

FIG. 12 shows a method of installing bait 1000 into ground 300. In this example, bait 1000 is pushed in the direction of arrow C into ground 300. As explained above, the configurations of head 100 shown in FIGS. 3-5 can be used for head 1100. These configurations can facilitate the insertion of bait 1000 into ground 300 by facilitating a twisting or rocking motion as bait 1000 is pushed into the ground. After bait 1000 is inserted to the desired depth, the ground may be pressed down or tamped down around bait 1000 to more securely fix bait 1000 into the ground.

Although the above description may contain specific details, they should not be construed as limiting the claims in any way. Other configurations of the described embodiments of the disclosed embodiments may be part of the scope of the disclosed embodiments. For example, the principles of the disclosed embodiments may be applied to each individual user where each user may individually deploy such a system. This be enables each user to utilize the benefits of the disclosed embodiments even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosed embodiments, rather than any specific examples given.

What is claimed is:

1. A bait for attracting animals and configured for inserting into the ground, the bait comprising:
a shaft portion having
a center portion having a first end and a second end, the first and second ends being at opposite ends along a longitudinal direction of the center portion, and
a protrusion extending from the center portion, the protrusion being adapted for engaging the ground as the center portion is inserted into the ground; and
a head portion attached to the second end of the center portion,
wherein the shaft portion and the head portion are a food for the animals.

2. The bait of claim 1, wherein the shaft portion and the head portion are made of a single material, the single material being the food for the animals.

3. The bait of claim 2, wherein the shaft portion and the head portion are made entirely of only the single material.

4. The bait of claim 3, wherein the first end of the center portion is smaller in cross section perpendicular to the longitudinal direction than the second end of the center portion.

5. The bait of claim 4, wherein the head portion has a cross section perpendicular to the longitudinal direction that is larger than a cross section of the second end of the center section that is perpendicular to the longitudinal direction.

6. The bait of claim 5, wherein the head portion includes a hole through the head portion extending in a transverse direction perpendicular to the longitudinal direction.

7. The bait of claim 6, wherein at least a portion of the center section is conical.

8. The bait of claim 1, wherein the protrusion is a barb.

9. The bait of claim 8, wherein the barb extends completely around the center portion.

10. The bait of claim 1, wherein the shaft portion has a plurality of protrusions and the protrusions are barbs.

11. The bait of claim 1, wherein the first end of the center portion is smaller in cross section perpendicular to the longitudinal direction than the second end of the center portion.

12. The bait of claim 11, wherein the first end of the center section is pointed.

13. A bait for attracting animals and configured for inserting into the ground, the bait comprising:
a shaft portion having an engagement feature; and
a head portion attached to the shaft portion,
wherein the portion and the head portion are a food for the animals, and
the shaft portion is configured such that the engagement feature engages the ground and resists removal of the bait from the ground when the center portion is inserted into the ground.

14. The bait of claim 13, wherein the shaft portion and the head portion are made of a single material, the single material being the food for the animals.

15. The bait of claim 14, wherein the shaft portion and the head portion are made entirely of only the single material.

16. The bait of claim 15, wherein the shaft portion is pointed and an end opposite to the head portion.

17. The bait of claim 13, wherein the engagement feature is a barb.

18. The bait of claim 17, wherein the barb extends completely around the shaft portion.

19. The bait of claim 13, wherein the shaft portion has a plurality of engagement features and the engagement features are barbs.

20. The bait of claim 13, wherein at least a portion of the shaft portion is conical.
